(19) United States
(12) Patent Application Publication
(10) Pub. No.: US 2013/0185115 A1
(43) Pub. Date: Jul. 18, 2013

(54) PARKING REWARD SYSTEM

(71) Applicant: Leigh Vernon Regan, Balwyn (AU)

(72) Inventor: Leigh Vernon Regan, Balwyn (AU)

(21) Appl. No.: 13/876,233

(22) PCT Filed: Sep. 29, 2011
(86) PCT No.: PCT/AU2011/001249

§ 371 Date: Mar. 27, 2013

(30) Foreign Application Priority Data
Sep. 30, 2010 (AU) 2010904406

(51) Int. Cl. G06Q 30/02

(52) U.S. Cl. CPC G06Q 30/0232
USPC 705/7.29

(57) ABSTRACT

A combination parking and shopping system comprising a data collection system for collecting purchase data of a user of the system, a parking entry machine comprising a portable user device dispenser, and a parking station comprising an identity input device and a data input device. The data collection system comprises a data input device for receiving the purchase data from a portable user device, an identity input device for receiving a user identification input in association with the purchase data, and a communication interface for communicating with a user database adapted to store user records corresponding to respective users of the system. The records comprise purchase data of the respective users. The communication interface is adapted to output to the user database the purchase data received by the data input device in association with a user identifier comprising or derived from the user identification input received by the identity input device, for storage in a user record of the user database corresponding to the user identifier.

### FIELD OF THE INVENTION

The present invention relates to a system, method and computer program product for collecting data, and is of particular but by no means exclusive application in collecting purchase data of users of a parking or combined parking and shopping system.

### BACKGROUND OF THE INVENTION

Shoppers often have to pay a parking fee for parking their motor vehicle (for example, their car or motor cycle) at a carpark of a shopping centre. At such carparks, it is usually the case that the parking fee increases the longer the shopper's motor vehicle is parked in the carpark.

Parking coupons (sometimes referred to as “parking tickets” or “parking vouchers”) are sometimes used to determine the length of time shoppers have parked their motor vehicles. Typically, the parking coupon is dispensed to a shopper when the shopper enters the carpark.

In some shopping centres, discounts on parking fees are offered as an incentive to encourage shoppers to make purchases. However, while such discounts can serve as an incentive for shoppers who have parked their motor vehicles in the shopping centre's carpark, they do not provide any incentive for shoppers who have not parked their motor vehicles in the shopping centre's carpark. Moreover, such discounts also do not provide any incentive for shoppers to purchase any more than what is required to obtain the maximum possible parking discount.

### SUMMARY OF THE INVENTION

According to a first broad aspect of the present invention, there is provided a data collection system for collecting purchase data (for example, data indicative of or related to payment for one or more goods or services) of a user of the system, the system comprising:

a data input device for receiving the purchase data from a portable user device;

an identity input device for receiving a user identification input (such as an alphanumeric code) in association with the purchase data; and

a communication interface for communicating with a user database adapted to store user records corresponding to respective users of the system and comprising purchase data of the respective users, wherein the communication interface is adapted to output to the user database the purchase data received by the data input device in association with a user identifier comprising or derived from the user identification input received by the identity input device, for storage in a user record of the user database corresponding to the user identifier.

In an embodiment, receiving the user identification input directly before or after the purchase data constitutes receiving the user identification input in association with the purchase data. In an embodiment, outputting the purchase data directly before or after the user identifier constitutes outputting the purchase data in association with the user identifier.

In an embodiment, the data collection system further comprises at least one data output device, each data output device being adapted to output purchase data to the portable user device. In addition, the data collection system may further comprise a portable user device dispenser for dispensing the portable user device to the user.

In an embodiment, the portable user device is a smart card adapted to store the purchase data, the data input device is a smart card reader adapted to read the purchase data from the smart card, the portable user device dispenser is a smart card dispenser adapted to dispense the smart card, and each data output device is a smart card writer adapted to write purchase data on the smart card.

The user database may be part of the data collection system. Persons skilled in the art will appreciate that the user database may also be implemented standalone device.

In an embodiment, the system is adapted to collect purchase data of a plurality of users of the system, and the communication interface is adapted to output to the user database purchase data of respective users in association with user identifiers comprising or derived from respective user identification inputs.

According to another aspect of the present invention, there is provided a parking system comprising the above data collection system, the parking system comprising: a parking entry machine comprising the portable user device dispenser; and a parking station comprising the identity input device and the data input device, wherein the portable user device is adapted to store parking data and purchase data.

To facilitate use of the purchase data at a later time, the parking station may be adapted to retrieve the purchase data from the user database according to the user identifier. Besides purchase data, the data input device may also be adapted to receive parking data from the portable user device. In addition, the parking station may be adapted to determine a parking fee based on the purchase data retrieved from the user database, the purchase data received from the portable user device, and the parking data received from the portable user device.

To facilitate reception of the user identification input, the identity input device may comprise a keypad. Alternatively, the identity input device may comprise a touch screen for allowing the user to select one of a plurality of user identification inputs. In another embodiment, the identity input device may comprise both a keypad and a touch screen.

In an embodiment, each smart card writer is connected to a point of sale device. In addition, the purchase data may be purchase data of the user or of another user.

According to yet another aspect of the present invention, there is provided a method of collecting purchase data of a user using a data collection system comprising a data input device, an identity input device and a communication interface, the method comprising: receiving the purchase data from a portable user device in association with a user identification input, the user identification input and the purchase data being received respectively by the data input device and the identity input device; and outputting the purchase data in association with a user identifier comprising or derived from the user identification input using the communication interface to a user database for storage in a user record of the user database corresponding to the user identifier.

### BRIEF DESCRIPTION OF THE DRAWINGS

In order that the invention may be more clearly ascertained, embodiments will now be described, by way of example, with reference to the accompanying drawings, in which:

FIG. 1 is a schematic view of a data collection system according to an embodiment of the present invention; and

FIG. 2 is a flow chart of the operation of the data collection system of FIG. 1.

### DETAILED DESCRIPTION

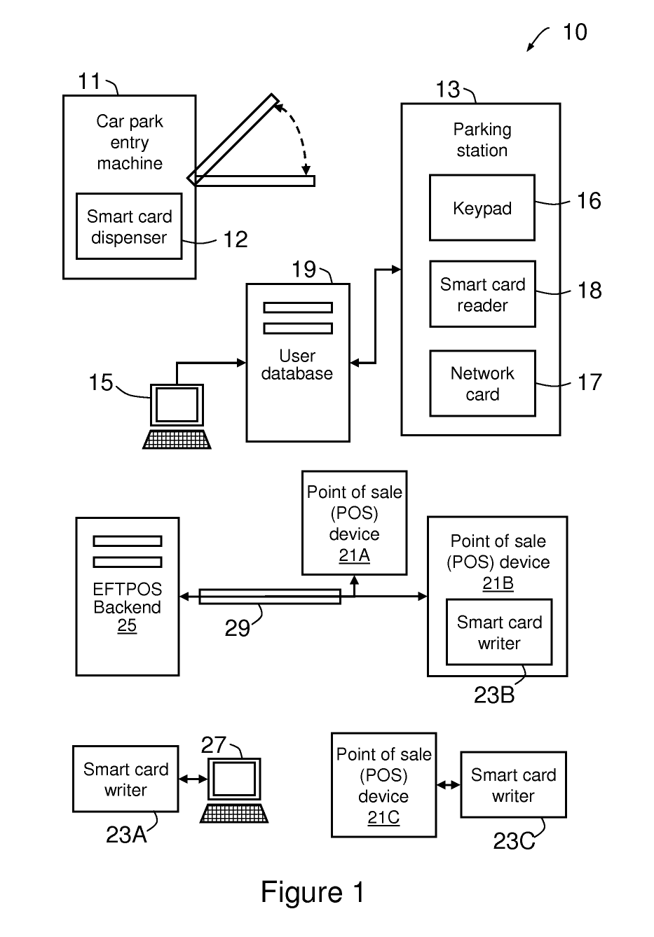

FIG. 1 is a schematic view of a data collection system 10 according to an embodiment of the present invention. The data collection system 10 is provided as part of a combined car parking and shopping system for administering a carpark of a shopping centre. Persons skilled in the art will appreciate that the data collection system may be provided in other environments where collecting purchase data of users is desirable. For example, the data collection system may also be used to collect purchase data of users purchasing goods and/or services in a shopping district.

The data collection system 10 is arranged to collect purchase data (for example, data indicative of the amount paid for one or more goods or services, or alternatively time credits earned by the purchase of the one or more goods or services) of users in a user database 19 adapted to store user records comprising purchase data corresponding to respective users. In use, the system 10 receives user identification inputs in association with purchase data from portable user devices (such as smart cards). User identifiers comprising or derived from respective user identification inputs are then output to the user database 19 in association with the purchase data for storage in a user record of the user database 19 corresponding to the user identifier.

The data collection system 10 comprises a parking station having a data input device 18 for receiving the purchase data, an identity input device 16 for receiving the user identification input, and a communication interface 17 adapted to output data to the user database 19. Persons skilled in the art will appreciate that the data input device, identity input device and communication interface may not be implemented together in a parking station. For example, the data input device, identity input device and communication interface may be implemented as separate devices, which may be located at the same or different physical locations. It is also envisaged that data input device, identity input device and communication interface may be incorporated into devices already existing in a shopping centre. For example, the data input device, identity input device and/or communication interface may be incorporated into an auto pay station existing in the shopping centre.

In this embodiment, the data input device 18 in the form of a smart card reader adapted to receive purchase data from a portable user device. The portable user device is a smart card that is arranged to store both parking data and purchase data. One example of a suitable smart card is the “MiFare card” (a contactless smartcard conforming the ISO 14443 industry standard). In use, the smart card reader 18 receives purchase data and/or parking data when a user swipes or touches the smart card against the smart card reader 18, or otherwise brings the smart card into close proximity with the smart card reader 18. Persons skilled in the art will appreciate that the term “smart card” also cover any type of contact or contactless card that is suitable for storing purchase and/or parking data and/or other relevant data, for example user identification data, including certain types of credit/debit cards. Also, it is envisaged that the portable user device is not limited only to smart cards and that it includes any portable user device that can store purchase data. For example, the portable user device may alternatively be a flash card, a USB storage device, a mobile phone, or any other device capable of storing data.

The purchase data is indicative of or is related to one or more payments for one or more products purchased in the shopping centre. The products can comprise goods (such as a piece of clothing purchased at a retail shop in the shopping centre) or services (such as dry cleaning paid for at a dry cleaner in the shopping centre). It is envisaged that the form of the purchase data can be price data indicative of an amount of money spent, time data indicative of how much time credit has been earned by a user through purchasing of products, or any other appropriate data related to the payments for products purchased. Furthermore, it is envisaged that the purchase data may be mixed data, for example the form of the purchase data stored in the user database may be different to the form of the purchase data stored in the portable user device. In this embodiment, the parking data comprises the actual time and date of entry of a motor vehicle. However, it is envisaged that parking data can be any form of data that can be used to determine the length of time a user has parked his or her motor vehicle in the carpark of the shopping centre. For example, instead of the actual time and date of entry of the motor vehicle, the parking data may be a computer generated clock value. Furthermore, the parking data can further comprise data not related to determining time within the carpark, for example parked vehicle location information.

The identity input device 16 is in the form of a keypad adapted to receive a user identification input in association with the purchase data. In use, the keypad 16 receives a user identification input when the user enters the alphanumeric code using the keypad. Persons skilled in the art will appreciate that in some other embodiments the identity input device may alternatively be a touch screen, a credit/debit card reader, a fingerprint reader, an iris recognition device, a near field communication device or any device that is suitable for identifying a user. Alternatively, the identity input device may be a virtual device that the user interacts with using an internet based platform, for example via a web browser or other application on a mobile phone.

In this embodiment, receiving the user identification input immediately before or after the purchase data constitutes receiving the user identification input in association with the purchase data. That is, the user identification input received by the keypad 16 and the purchase data received by the smart card reader 18 are associated by virtue of being received in sequence one immediately after another. Persons skilled in the art will appreciate that this association does not require that the purchase data be received immediately before or after the user identification input. For example, purchase data may be received in association with a first of a sequence of user identification input by virtue of being the first purchase data received immediately after the sequence of user identification inputs are received. It is envisaged that this association may involve additional input from the user. For example, the parking station 13 may require that the user operate the keypad to associate the user identification input with the purchase data. It is also envisaged that, in an alternative embodiment, the identity input device is a credit/debit card reader instead of a keypad and that the user identification input may be a credit/debit card number. In such an embodiment, the user identification input is provided once a user swipes his/her credit/debit card against the credit/debit card reader.

In the system 10, the user identification input is a unique alphanumeric code. Persons skilled in the art will appreciate that the alphanumeric code can be a user's name, a user's date of birth, or a loyalty card number etc. Persons skilled in the art will also appreciate that in some embodiments the user identification input may not be an alphanumeric code and that the user identification input can be any input that can be used to determine the identity of the user. For example, in an alternative embodiment, the user identifier may be a biometric identifier (such as a user's thumbprint or iris pattern). Persons skilled in the art will appreciate that the user identification input can comprise a combination of numbers, characters and/or biometric identifiers. It is further envisaged that a user may associate a data input device with their user identifier, for example such that during subsequent use of the data input device by the user, if a user identifier is required, the user identifier is supplied by the data input device rather than the user.

The communication interface 17 is in the form of a network card 17 adapted to communicate purchase data in association with a user identifier to a user database 19 adapted to store user records corresponding to respective users and comprising purchase data of the respective users. The user identifier is an identifier comprising or derived from the user identification input. In the system 10, the user identifier is the same as the user identification input. However, it is envisaged that in some embodiments the user identifier is different from the user identification input. For example, the user identifier may be a filename that is derived from the user identification input. In the system 10, the user database is adapted to store user records comprising purchase data and parking data. However, it is envisaged that the user database may also store other user data such as a user's contact details (such as address, telephone number etc) and preferences (such as favourite brand of clothing, favourite retail shop etc).

In this embodiment, the identity input device 16, the data input device 18 and the communication interface 17 are provided as part of a parking station 13. It is envisaged that the parking station 13 is located within the shopping centre carpark. Persons skilled in the art will appreciate that the system may include multiple parking stations.

In this embodiment, the purchase data is the user's own purchase data (that is, the data relating to payment for goods made by or on behalf of the user). However, it is envisaged that this need not always be the case; in another embodiment, the purchase data may be another user's purchase data, or indeed be the purchase data of a plurality of users.

The data collection system also comprises a portable user device dispenser 12 adapted to dispense a portable user device to a user. In this embodiment, the portable user device dispenser is provided in the form of a smart card dispenser 12 and is a part of a carpark entry machine 11.

The smart card dispenser 12 is adapted to dispense the smart card to a user. In this embodiment, the carpark entry machine 11 is connected to induction coils (not shown) that are adapted to automatically detect the presence of a car. In use, a signal is communicated from the induction coils to the car park entry machine 11 when the induction coils detect the presence of a car. In response to receiving the signal, the smart card dispenser 12 of the car park entry machine 11 dispenses a smart card. Persons skilled in the art will appreciate that in an alternative embodiment, the system may not include induction coils but rather some other means that triggers the dispensing of smart cards. For example, the carpark entry machine 11 may have a button that may be operated by a user to dispense a smart card.

In this embodiment, the carpark entry machine 11 also includes a boom gate. The boom gate is arranged to rise up in response to a communication from the smart card dispenser 12 that a user has taken the smart card dispensed by the smart card dispenser 12. Persons skilled in the art will appreciate that the carpark entry machine need not include the boom gate. Furthermore, persons skilled in the art will appreciate that the smart card dispenser may allow for permanently issued user identification devices, for example permanently issued smart cards, to be used in place of smart cards dispensed by the smart card dispenser 12. In this instance, the permanently issued user identification devices act as the smart cards except that, rather than being dispensed, the permanently issued user identification devices are activated by the smart card dispenser by recording the entry times onto the permanently issued user identification devices. It is further envisaged that the permanently issued identification devices may include user identifiers, such that users are not required to manually enter their user identifiers.

The data collection system includes three point of sale (POS) devices 21A,21B,23C. Typically, POS devices are hardware and software terminals that facilitate the payment for goods and/or services. It is envisaged that the POS devices are located at check out or POS points at different shops in the shopping centre. In this embodiment, two of the POS devices 21A,21B are connected, via a local area network 29, to an Electronic Fund Transfer at Point of Sale (EFTPOS) backend 25. Persons skilled in the art will appreciate that the EFTPOS backend comprises hardware and software components for facilitating electronic transactions including electronic funds transfer, credit or debit card payments. In contrast to POS devices 21A,21B, the third POS device 21C is not connected to the EFTPOS backend.

The data collection system 10 also comprises at least one data output device, each data output device being adapted to communicate purchase data to the portable user device (that is, the smart card). The data output devices are in the form of smart card writers 23A,23B,23C.

In FIG. 1, one of the smart card writers 23B is provided as part of the POS device 21B. Another one of the smart card writer 23C is connected to one of the POS device 21C as a separate device. In use, purchase data indicative of a payment for a product can be communicated from POS device 21B or 21C via smart card writer 23B or 23C to the smart card upon payment for the product at the POS device 21B or 21C. That is, purchase data can be communicated by these smart card writers to the smart card upon a user making payment (and providing his or her smart card) at the respective POS devices 21B,21C.

It is envisaged that the local area network is administered by the proprietor of the shopping centre (and the shopping centre carpark) or a third party server provider, and that the POS device 21B is located in a shops that is also managed by (or otherwise affiliated with) the proprietor of the shopping centre. Conversely, it is envisaged that the POS devices 21A,21C are located in shops not managed by the proprietor but by an independent retailer.

The data collection system 10 also comprises a smart card writer 23A connected to a computer 27. If a product is paid by a user using POS device 21A, the computer 27 can be used to communicate purchase data from the smart card writer 23A to the smart card. It is envisaged that the computer 27 is located at an information counter in the shopping centre and that an employee operates the computer 27 to communicate purchase data from the smart card writer 23A to the smart card when a user presents an appropriate receipt of purchase at the information counter.

In this embodiment, each POS device is connected to either the EFTPOS Backend 25 or a smart card writer. However, it is envisaged that this need not always be the case. For example, in an alternative embodiment, the system may additionally include a POS device which is not connected to either the EFTPOS Backend 25 or a smart card writer.

In this embodiment, the purchase data communicated from a smart card writer to the smart card comprises a shop identifier and the amount of money spent in the shop (that is, an identifier that uniquely identifies the shop). For example, if a user makes three purchases in a shop, the purchase data includes a shop identifier and the total amount of money paid by the user for the three purchases. However, it is envisaged that the purchase data communicated from a smart card writer to the smart card may not be a shop identifier and the amount of money spent in the shop and can be in another format. For example, purchase data communicated from a smart card writer to the smart card can be just a running total of the amount of money spent in the shopping centre. In such an example, the POS device also comprises a smart card reader, and when in use, the POS device reads the running total in the smart card, updates the running total, and communicates it back to the smart card. The purchase data can optionally include further details about the purchases as necessary.

The parking station 13 is connected to a user database 19 adapted to store a plurality of user records corresponding to respective users of the data collection system 10, each user record comprising purchase data of a different user. The user database 19 is also connected to a second computer 15 for allowing a user to sign up as a new user of the data collection system 10. It is envisaged that the parking station can also additionally serve as a device conveniently located between the carpark and the general retail shops for signing up new users. That is, the parking station can also be a user registration device for allowing shoppers to sign up as users of the parking system prior to commencing shopping. In this embodiment, the user database is a stand alone device. However, it is envisaged that the user database can alternatively be part of the parking station, be located remotely etc.

The user database 19 stores users' purchase data in separate user records corresponding to respective user identifiers. In the system 10, each user identifier comprises a user identification input. Persons skilled in the art will appreciate that the user identifier may not comprise the user identification input but may alternatively be derivable based on the user identification input. For example, the user identifier may be data identifying the location of the user record in the user database. To communicate purchase data in association with a user identifier to the user database 19, the parking station 13 transmits the purchase data in sequence to the user database so that the purchase data is stored against a particular user record. Accordingly, the system outputs the purchase data in association with the user identifier by outputting the purchase data immediately before or after the user identifier.

The parking station 13 is also adapted to determine a parking fee based on the purchase data received from the smart card reader 18, the user identification input (that is, the alphanumeric code) received by the keypad 16, and any purchase data existing in the user database 19. In use, the parking station 13 sends a request to retrieve any purchase data stored in the user database corresponding to the user identifier comprising the user identification input in response to the user inputting an alphanumeric code (that is, his or her user identification input) and swiping or touching the smart card against the smart card reader 18. The parking station then makes a determination of the parking fee based on the purchase data (if any) retrieved from the user database.

The data collection system is advantageous in that the purchase data stored in the user database can be later retrieved (for example, by the proprietor of the data collection system or by a third party) using just the user identification input to provide a benefit to the user. For example, the purchase data stored in the user database can be later retrieved to determine the amount of parking discount to be provided to a user. In another example, the purchase data stored in the user database can be later retrieved to determine the type of promotional information (such as invitation to pre public launching of fashion parades, mid/end year sales, movies launches, exclusive offers from retailers, latest release merchandise, giveaways etc) to send to users of the data collection system. In this respect, it is envisaged that promotional information may be sent to users either during or after each shopping trip. For example, promotional information (sales based on user preferences, purchase data history etc) may be sent to a user during a shopping trip after the user inputs his/her user identification input at the parking station before or during shopping.

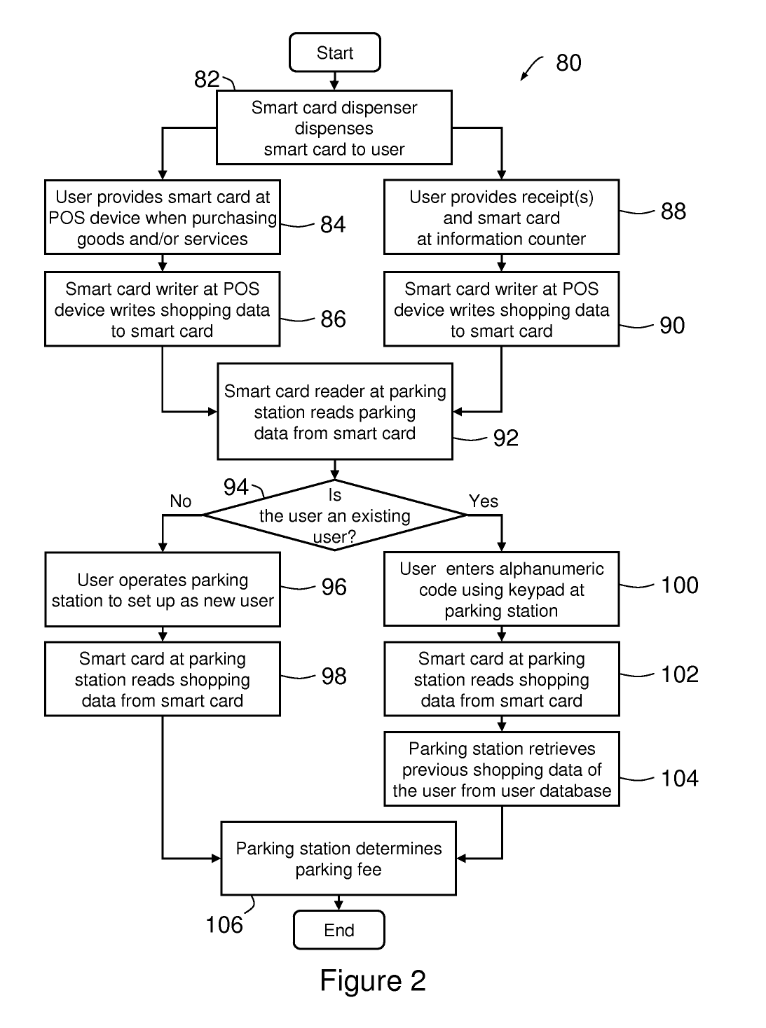

FIG. 2 is a flow diagram 80 of the operation of the data collection system 10 of FIG. 1.

At step 82, a user arrives at an entry point of the carpark of the shopping centre and the smart card dispenser 12 dispenses a smart card comprising parking data to the user.

The user proceeds into the shopping centre after parking the car in the carpark. The user then purchases a couple of products in the shopping centre. When making the first purchase, the user provides the smart card to the cashier at the POS device 21C together with payment for the first product at step 84. At step 86, the purchase data relating to payment of the first product is then transmitted from the smart card writer 23C connected to the POS device 21C to the smart card.

When making the second purchase, the user pays for the product at the check out point but does not provide the smart card to the cashier at the POS device 21A. At step 88, after making the second purchase, the user goes to an information counter and provides a receipt of purchase. At the information counter, the purchase data relating to the second product is then transmitted from the smart card writer 23A (connected to the computer 27 at the information counter) to the smart card at step 90.

After the user finishes shopping, the user proceeds to the parking station 13. At step 92, the user swipes the smart card against the smart card reader 18 so that parking data stored in the smart card is communicated from the smart card to the parking station 13.

At step 84, in response to communication of the parking data from the smart card to the smart card reader 18, the parking station 13 queries the user on whether he or she is an existing user of the parking system (that is, whether the user is someone who has previously signed up as a user of the parking system).

If the user is not an existing user, the parking station 13 proceeds to direct the user to sign up as a new user of the parking system at step 96. During the signing up process, the user (now a new user) is provided with a new identification input in the form of an alphanumeric code.

At step 98, after the sign up process, the parking station 13 then prompts the user to swipe the smart card against the smart card reader 18 again so that the smart card reader 18 receives the purchase data stored in the smart card. That is, after the user swipes the smart card against the smart card reader 18, the data input device 38 receives from the portable user device the purchase data communicated from each data output device 33 to the portable user device. Persons skilled in the art will appreciate that in another embodiment, the smart card reader 18 can be arranged to receive both parking data and purchase data simultaneously and accordingly, the user need only swipe the smart card once against the smart card reader 18.

A user identifier (which in this embodiment is the same as the user identification input) and the purchase data are then communicated from the parking station 13 to the user database 19 via network card 17. As indicated previously, the purchase data and the user identifier are sent in association to the user database by virtue of being sent in sequence one after another. A new user record is then created in the user database corresponding to the new user.

At step 106, the parking station 13 determines the amount of money the user is required to pay for parking (that is, the parking fee) based on the purchase data and parking data communicated from the smart card to the parking station.

At step 94, if the user is an existing user (that is, a user that previously has signed up as a user of parking system), the parking station 13 prompts the user to enter his or her user identification input (that is, an alphanumeric code) using the keypad 16 at step 100.

At step 102, the parking station 13 then prompts the user to again swipe the smart card against the smart card reader 18 so that the smart card reader 18 receives the purchase data stored in the smart card.

At step 104, the parking station 13 then retrieves any previous purchase data of the user from the user database 19 based on a user identifier (which in this embodiment is the same as the user identification input) entered by the user using keypad 16.

The parking station 13 then determines the amount of money the user is required to pay for parking based on the purchase data and parking data communicated from the smart card to the parking station 106 and the previous purchase data associated with the user identifier retrieved from the user database step 104.

Examples of a User Identifier, Parking Data, Purchase Data, and How the Parking Station Determines a Parking Fee

The following provides a description of an example of the user identifier, an example of the parking data, an example of the purchase data, and an example of how the parking station determines a parking fee in the above embodiment.

An example of the user identifier (and the user identification input) is an alphanumeric code 123456. In such an example, each user record stored in the user database contains the following user details: name; gender; age; address; home telephone number; work telephone number; and mobile telephone number.

In an example, the following parking and purchase data are stored in the smart card:

Date: 6 Jul. 2010

Time of entry into carpark: 10 am

| Shop | Spending |
|---|---|
| Smart card reader no. 1 | $20 |
| Smart card reader no. 17 | $50 |
| Smart card reader no. 28 | $80 |
| Smart card reader no. 119 | $100 |

As shown above, each smart card reader is numbered and is registered against a shop identifier which is stored in the master database.

In an example, the parking station of this embodiment determines a parking fee as follows:

| Time read from smartcard at | 12 | noon |
|---|---|---|
| parking station | | |
| Total amount of money spent in | $250.00 | |
| the shopping trip | | |
| Balance of parking hours | 26 | hours |
| retrieved from user database | | |
| Parking hours accrued in the | 12.5 | hours |
| shopping trip | | |
| Total parking hours (Balance of | 38.5 | hours |
| parking hours retrieved from user | | |
| database + Parking hours accrued in the | | |
| shopping trip) | | |
| Hours of parking in the shopping | 2 | hours |
| trip | | |
| Carried forward parking hours | 36.5 | hours |

In the example, the user has shopped for 2 hours (from 10 am to 12 noon). The parking fee of the shopping centre's carpark is $4 per hour. Accordingly, the total parking fee for this trip is $8. In the example, the shopping centre provides a parking discount of $2 per hour for every $20 spent in the shopping centre (that is, half-price parking for every $20 spent in the shopping centre). Accordingly, a $4 is discount is applicable. Thus, the parking fee in the example is $4.

In the example, the user has a balance of 26 hours prior to this shopping trip. Thus, the user has sufficient hours for receiving the $4 discount on parking. As the user has spent $250 on the shopping trip, the user also accrues additional hours of 12.5 hours in this trip that can be used to provide parking discounts for future trips to the shopping centre. Accordingly, 2 hours out of the 38.5 hours (26 hours+12.5 hours) is used for parking in this shopping trip and the user has a carried forward total of 36.5 hours that can be used to provide parking discounts for future trips to the shopping centre.

Modifications within the scope of the invention may be readily effected by those skilled in the art. It is to be understood, therefore, that this invention is not limited to the particular embodiments described by way of example hereinabove.

In the claims that follow and in the preceding description of the invention, except where the context requires otherwise owing to express language or necessary implication, the word “comprise” or variations such as “comprises” or “comprising” is used in an inclusive sense, that is, to specify the presence of the stated features but not to preclude the presence or addition of further features in various embodiments of the invention.

Further, any reference herein to prior art is not intended to imply that such prior art forms or formed a part of the common general knowledge in Australia or any other country.

1. A data collection system for collecting purchase data of a user of the system, the system comprising:
a data input device for receiving the purchase data from a portable user device;
an identity input device for receiving a user identification input in association with the purchase data; and
a communication interface for communicating with a user database adapted to store user records corresponding to respective users of the system, said records comprising purchase data of the respective users,
wherein the communication interface is adapted to output to the user database the purchase data received by the data input device in association with a user identifier comprising or derived from the user identification input received by the identity input device, for storage in a user record of the user database corresponding to the user identifier.

2. The data collection system as claimed in claim 1, wherein the purchase data is indicative of a payment for one or more products.

3. The data collection system as claimed in claim 2, wherein the products comprise goods or services.

4. The data collection system as claimed in claim 1, wherein the user identification input is an alphanumeric code.

5. The data collection system as claimed in claim 1, wherein receiving the user identification input immediately before or after the purchase data constitutes receiving the user identification input in association with the purchase data.

6. The data collection system as claimed in claim 1, wherein outputting the purchase data immediately before or after the user identifier constitutes outputting the purchase data in association with the user identifier.

7. The data collection system as claimed in claim 1, further comprising at least one data output device, each data output device being adapted to output purchase data to the portable user device.

8. The data collection system as claimed in claim 1, further comprising a portable user device dispenser for dispensing the portable user device to the user.

9. The data collection system as claimed in claim 8, wherein the portable user device is a smart card adapted to store the purchase data, the data input device is a smart card reader adapted to read the purchase data from the smart card, the portable user device dispenser is a smart card dispenser adapted to dispense the smart card, and each data output device is a smart card writer adapted to write purchase data on the smart card.

10. The data collection system as claimed in claim 1, comprising the user database.

11. The data collection system as claimed in claim 1, wherein the system is adapted to collect purchase data of a plurality of users of the system, and the communication interface is adapted to output to the user database purchase data of respective users in association with user identifiers comprising or derived from respective user identification inputs.

12. A parking system comprising a data collection system as claimed in claim 8, the parking system comprising:
a parking entry machine comprising the portable user device dispenser; and
a parking station comprising the identity input device and the data input device,
wherein the portable user device is adapted to store parking data and purchase data.

13. The parking system as claimed in claim 12, wherein the parking station is adapted to retrieve purchase data corresponding to the user identifier from the user database.

14. The parking system as claimed in claim 12, wherein the data input device is adapted to receive parking data from the portable user device.

15. The parking system as claimed in claim 14, wherein the parking station is adapted to determine a parking fee based on the purchase data retrieved from the user database, the purchase data received from the portable user device, and the parking data received from the portable user device.

16. The parking system as claimed in claim 12, wherein each smart card writer is connected to a point of sale device.

17. The parking system as claimed in claim 12, wherein the identity input device comprises a keypad.

18. The parking system as claimed in claim 12, wherein the identity input device comprises a touch screen for allowing the user to select one of a plurality of user identification inputs.

19. The parking system as claimed in claim 12, wherein the purchase data is purchase data of the user.

20. The parking system as claimed in claim 12, wherein the purchase data is purchase data of another user.

21. A method of collecting purchase data of a user using a data collection system comprising a data input device, an identity input device and a communication interface, the method comprising:
receiving the purchase data from a portable user device in association with a user identification input, the user identification input and the purchase data being received respectively by the data input device and the identity input device; and
outputting the purchase data in association with a user identifier comprising or derived from the user identification input using the communication interface to a user database for storage in a user record of the user database corresponding to the user identifier.

22. (canceled)

23. (canceled)

24. (canceled)
